(19) United States
(12) Patent Application Publication
(10) Pub. No.: US 2012/0276328 A1
(43) Pub. Date: Nov. 1, 2012

(54) MULTI-PLY PAD

(76) Inventor: Ting-Chun CHEN, Miaoli County (TW)

(21) Appl. No.: 13/207,038

(22) Filed: Aug. 10, 2011

(30) Foreign Application Priority Data
Apr. 26, 2011 (TW) 100114468

(51) Int. Cl. B32B 3/10

(52) U.S. Cl. 428/131

(57) ABSTRACT

A multi-ply pad includes a base layer, an intermediate member and a top layer, which are made of a resilient material. The intermediate member is sandwiched between the base layer and the top layer and provided with a plurality of through holes each having a predetermined shape. A plurality of parts of the top layer, which correspond in location to the through holes of the intermediate member respectively, are respectively embedded into the through holes of the intermediate member and attached on a plurality of parts of the base layer, which correspond in location to the through holes of the intermediate member, such that a plurality of concavities and a plurality of convexities defined between the concavities are formed on a top surface of the multi-ply pad.

### BACKGROUND OF THE INVENTION

1. Field of the Invention

The present invention relates generally to cushion pads for human wears and more particularly, to a multi-ply pad for a sports wear.

2. Description of the Related Art

Conventionally, a resilient cushion pad is generally used to be sewed on the part of a sports wear corresponding to the body of the wearer that tends to get injury in exercising for protecting the wearer from injury during exercising. U.S. Pat. No. 6,743,325 disclosed a flexible material suitable for being used as the aforementioned resilient cushion pad. As shown in the drawings of the aforesaid patent, the flexible material includes a plurality of cutter-made separate resilient cubes joined on a knitted fabric.

The above-mentioned flexible material may have the following disadvantages. When the flexible material is used as a cushion pad, e.g. a cushion pad to be attached on a knee protection, the worker has to cut the sheet of the flexible material into a shape corresponding to the configuration of the target to which the cushion pad is to be attached. This kind of processing work is usually time- and labor-consuming. In addition, the cut flexible material provides no parts suitable for being sewed or attached on the target wear; therefore, the work of attaching the flexible material on the wear can not be done speedily and conveniently. Further, because the separate cubes of the flexible material have a same configuration, the flexible material can only provide a uniform resilience at the whole area thereof. In other words, the flexible material can not provide a required resilience according to the user's need at a specific portion thereof.

### SUMMARY OF THE INVENTION

The present invention has been accomplished in view of the above-noted circumstances. It is therefore the primary objective of the present invention to provide a multi-ply pad, which can be pre-formed having a configuration fittable with a target wear for being directly sewed on the target wear by a user.

Another objective of the present invention is to provide a multi-ply pad having a pre-formed, thin plate-like margin for facilitating the user to attach the multi-ply pad to a wear.

Still another objective of the present invention is to provide a multi-ply pad, which can be configured having different resiliencies distributed on different parts thereof according to the need of the user or the portion to which the multi-ply pad is to be attached.

To achieve the above-mentioned objectives, the multi-ply pad provided by the present invention comprises a base layer of a resilient material, a top layer having a main body configured corresponding to the base layer and made of a resilient material, and an intermediate member of a resilient material sandwiched between the base layer and the top layer. The intermediate member has a plurality of through holes with a predetermined shape. The parts of the top layer, which correspond in location to the through holes of the intermediate member respectively, are respectively embedded into the through holes of the intermediate member and attached on the parts of the base layer, which correspond in location to the through holes of the intermediate member, such that a plurality of concavities and a plurality of convexities defined between the concavities are formed on a top surface of the multi-ply pad.

Another feature of the multi-ply pad of the present invention lies in that the intermediate member has a size smaller than the sizes of the base layer and the top layer, such that after the base layer, the intermediate member and the top layer are laminatedly bonded together, a periphery margin of the base layer and a periphery margin of the top layer are directly bonded with each other to form a flat margin around the top surface of the multi-ply pad.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a multi-ply pad in accordance with a first preferred embodiment of the present invention;

FIG. 2 is an exploded view of the multi-ply pad shown in FIG. 1;

FIG. 3 is a cross-sectional view taken along line 3-3 of FIG. 1;

FIG. 4 is a schematic drawing showing that the multi-ply pad of the first preferred embodiment of the present invention is used on a wear;

FIG. 5 is a top view of a multi-ply pad according to a second preferred embodiment of the present invention;

FIG. 6 is a cross-sectional view taken along line 6-6 of FIG. 5;

FIG. 7 is a top view of a multi-ply pad according to a third preferred embodiment of the present invention, and

FIG. 8 is a cross-sectional view taken along line 8-8 of FIG. 7.

### DETAILED DESCRIPTION OF THE INVENTION

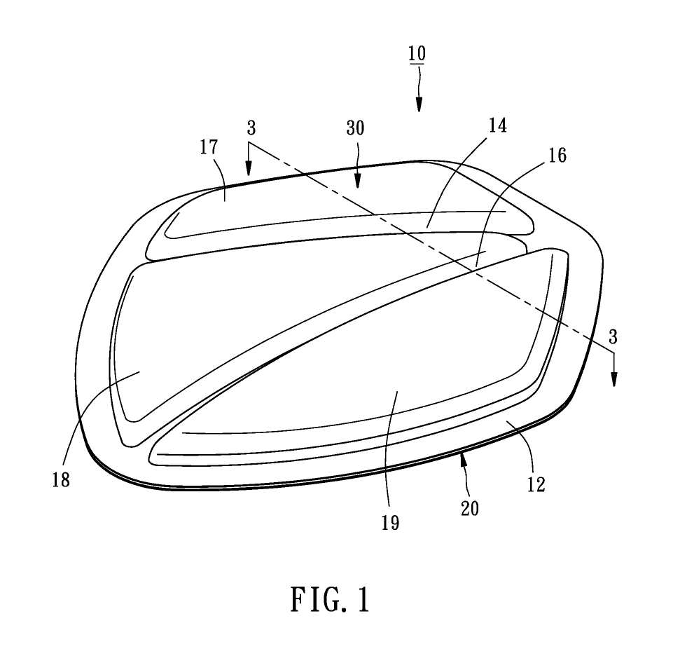

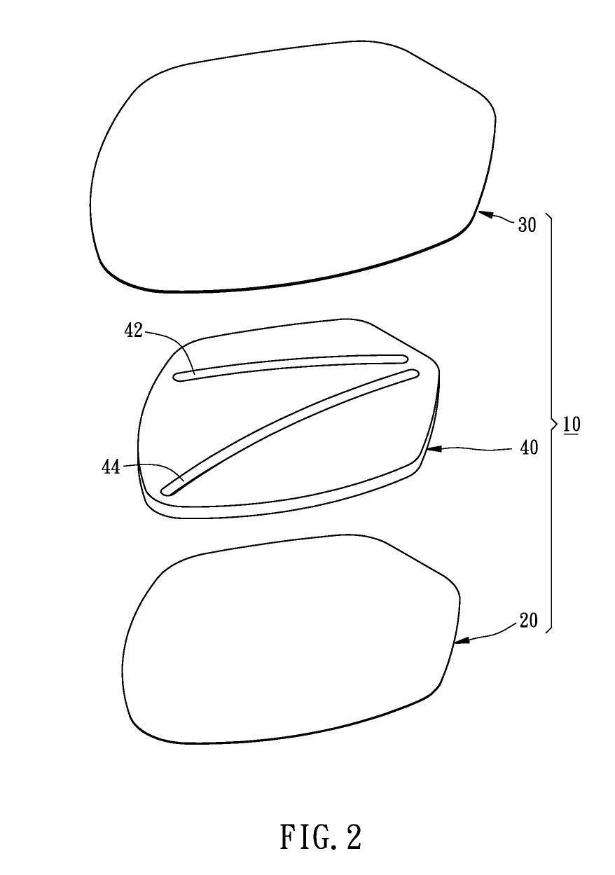

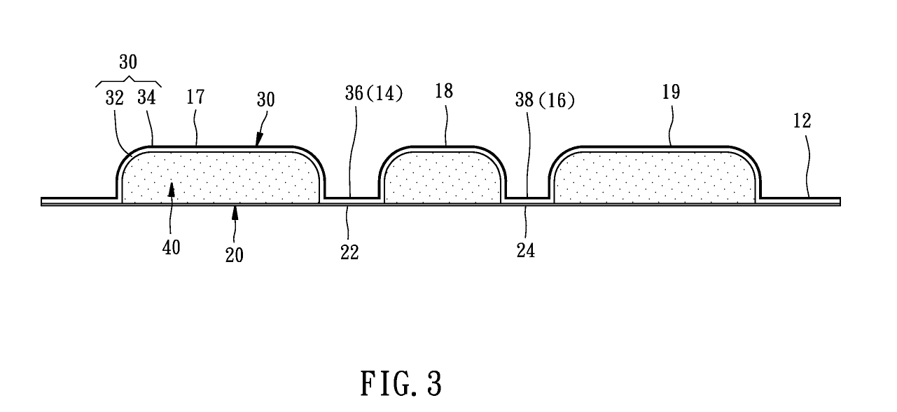

As shown in FIGS. 1-3, a multi-ply pad, provided by a first preferred embodiment of the present invention and denoted by reference numeral 10 in the drawings, is configured as an irregular pentagonal member in this embodiment. It'll be appreciated that the configuration of the multi-ply pad 10 of the present invention may vary according to the configuration of the part of the wear, to which the multi-ply pad 10 is to be attached. In other words, the configuration of the multi-ply pad 10 is not limitative of the scope of the present invention to be claimed.

Structurally, the multi-ply pad 10 comprises a base layer 20, a top layer 30 and an intermediate member 40. The base layer 20 is made of a polyurethane foam material having a predetermined thickness, e.g. 2 mm in this embodiment. The top layer 30 is composed of a main body 32 and an outer covering 34 attached on the surface of the main body 32. The main body 32 is made of a polyurethane foam material having a thickness of 2 mm. Alternatively, a polyurethane foam material having a different thickness can also be used as the main body 32. For the outer covering 34, a fabric can be used. In this preferred embodiment, the base layer 20 and the top layer 30 have a same configuration.

The intermediate member 40 is also made of a polyurethane foam material having a thickness greater than those of the base layer 20 and the top layer 30, and an area smaller than those of the base layer 20 and the top layer 30. In this preferred embodiment, the thickness of the intermediate member 40 ranges from 4 to 6 mm. In addition, the intermediate member 40 has two elongated through holes 42 and 44 penetrating the top and bottom surfaces thereof. It is to be understood that the intermediate member 40 may have more through holes or through holes of different shapes.

In assembly, the intermediate member 40 is sandwiched between the base layer 20 and the top layer 30. In manufacturing, foam sheets of different thicknesses are respectively cut according to predetermined configurations into the base layer, intermediate member and top layer in advance, and then the base layer, the intermediate member and the top layer are attached one by one with glue, and thereafter the laminate including the base layer, the intermediate member and the top layer is put into a mould and then heat pressed at a predetermined pressure and a predetermined temperature to form the resultant as shown in FIG. 1. It is to be mentioned that the processing pressure, temperature and time for heat molding the multi-ply pad of the present invention will be determined according to the foam materials used. Since these processing factors are well-known to a person skilled in the related art, detailed description thereof needs not to be presented hereinafter for the purpose of concise illustration. In the process of manufacturing the pad 10, the parts 36 and 38 of the top layer 30, which correspond in location to the elongated through holes 42 and 44 of the intermediate member 40 respectively, will be pressed and embedded into the through holes 42 and 44 and then directly attached and bonded on the parts 22 and 24 of the base layer 20, which correspond in location to the elongated through holes 42 and 44 of the intermediate member 40 respectively, so as to form the concavities 14 and 16 and the convexities 17, 18 and 19.

In addition, since the areas of the base and top layers 20 and 30 are larger than the area of the intermediate member 40, the periphery margin of the base layer 20 and the periphery margin of the top layer 30 will be directly bonded with each other after molding to form a flat margin 12 around the top surface of the multi-ply pad 10, which is substantially flush with the concavities 14 and 16.

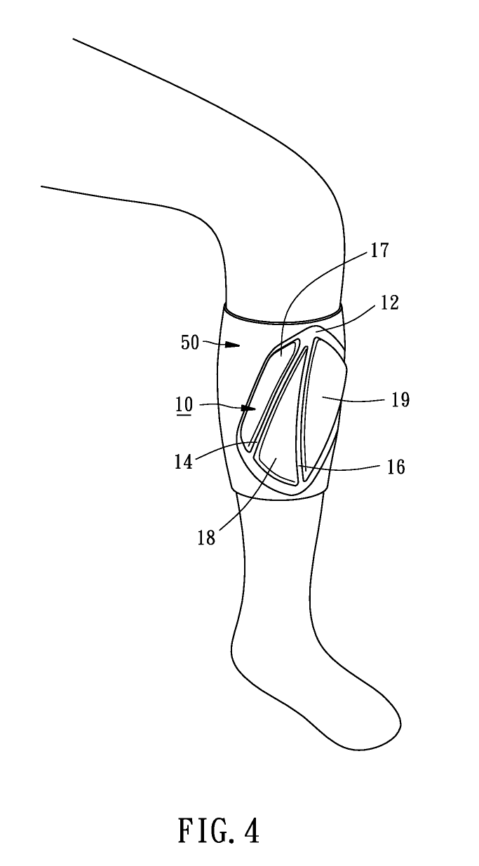

In use, the multi-ply pad 10 is sewed on a wear 50 by means of the margin 12, as shown in FIG. 4. After the wear 50, on which the multi-ply pad 10 is sewed, is worn on the body of a user, the multi-ply pad 10 becomes flexible and bendable thanks to the concavities 14 and 16, and on the other hand, the convexities 17, 18 and 19 of the pad 10 can provide sufficient protection to the user to prevent the user from injury.

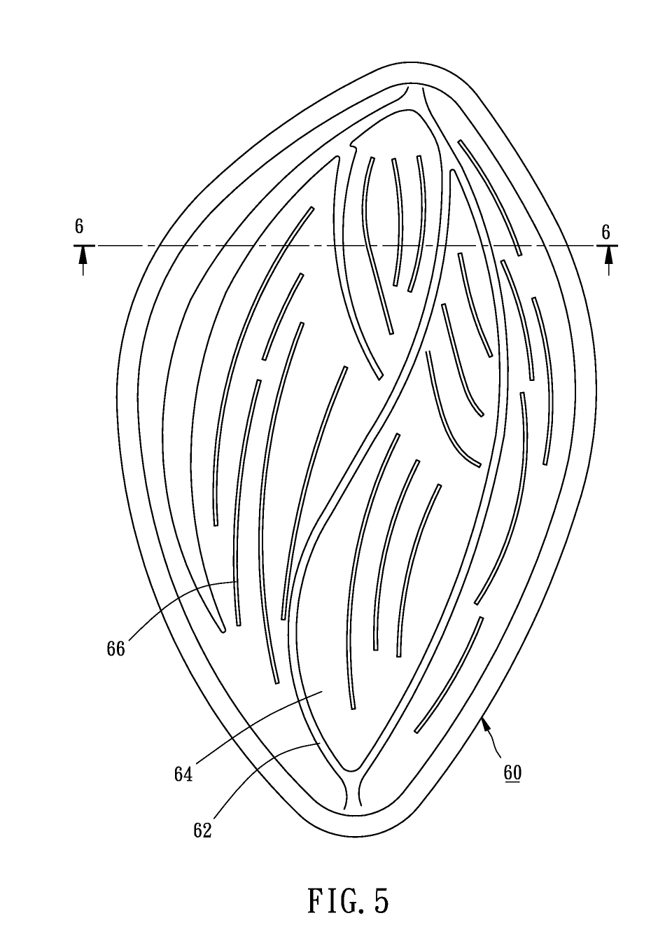

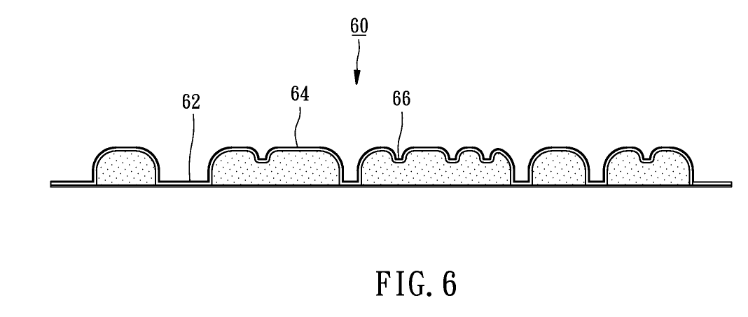

FIGS. 5-6 show a multi-ply pad 60 according to a second preferred embodiment of the present invention. The basic structure of the pad 60 is substantially the same as that of the pad 10 disclosed in FIGS. 1-3 except the following features.

The concavities 62 and convexities 64 of the multi-ply pad 60 are different in shape and amount from those of the pad 10. In addition, on the top surface of convexities 64 of the top layer 30 a plurality of elongated shallow grooves 66 are provided.

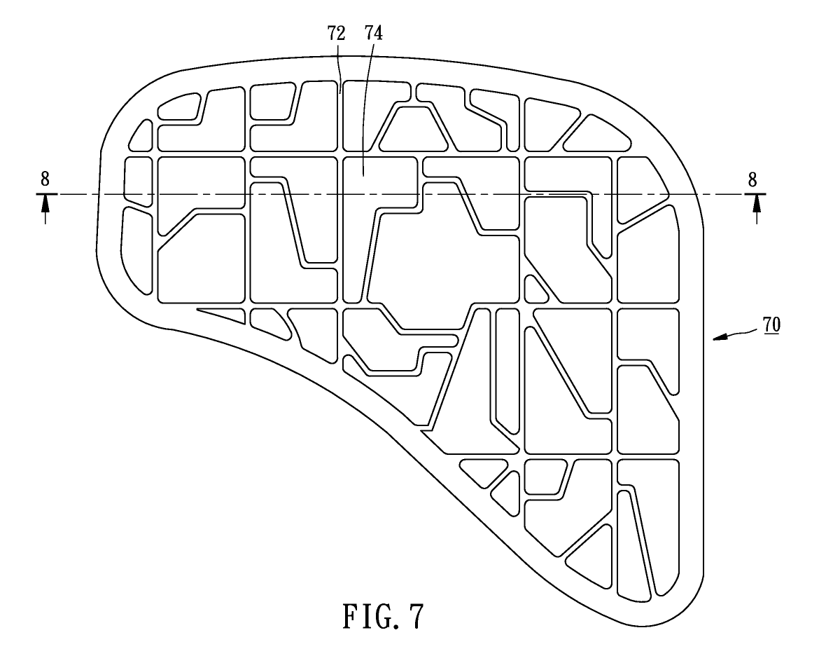

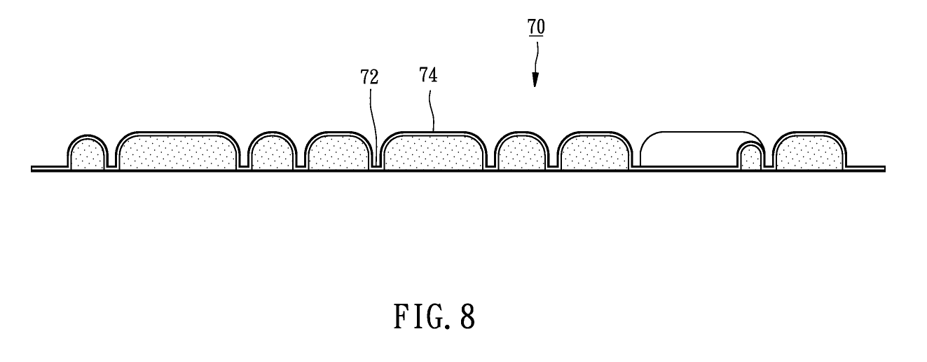

FIGS. 7-8 show a multi-ply pad 70 according to a third preferred embodiment of the present invention, which has basically the same structure as the pad 10 disclosed in FIGS. 1-3, except that the pad 70 has substantially an L-shape and the concavities 72 and convexities 74 of the pad 70 are different in shape and amount from those of the pad 10.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A multi-ply pad comprising:
a base layer made of a resilient material;
an intermediate member made of a resilient material and provided with a plurality of through holes each having a predetermined shape;
a top layer having a main body configured corresponding to the base layer and made of a resilient material;
wherein the intermediate member is sandwiched between the base layer and the top layer in a way that a plurality of parts of the top layer, which correspond in location to the through holes of the intermediate member respectively, are respectively embedded into the through holes of the intermediate member and attached on a plurality of parts of the base layer, which correspond in location to the through holes of the intermediate member, such that a plurality of concavities and a plurality of convexities defined between the concavities are formed on a top surface of the multi-ply pad.

2. The multi-ply pad as claimed in claim 1, wherein the top layer further comprises an outer covering attached on the main body.

3. The multi-ply pad as claimed in claim 2, wherein the base layer, the intermediate member and the top layer are laminated together by pressing.

4. The multi-ply pad as claimed in claim 1, wherein the intermediate member has a size smaller than the size of the base layer and the size of the top layer, such that a periphery margin of the base layer and a periphery margin of the top layer are directly bonded with each other to form a flat margin of the multi-ply pad after the base layer, the intermediate member and the top layer are laminatedly bonded together.

5. The multi-ply pad as claimed in claim 1, wherein the intermediate member has a thickness greater than the thickness of the base layer and the thickness of the top layer.

6. The multi-ply pad as claimed in claim 1, wherein the base layer, the intermediate member and the top layer are laminated together by pressing.

7. The multi-ply pad as claimed in claim 1, wherein the base layer, the intermediate member and the top layer are made of a polyurethane foam material.
